(19) United States
(12) Patent Application Publication
(10) Pub. No.: US 2009/0152257 A1
(43) Pub. Date: Jun. 18, 2009

(54) Electric Heating Device

(76) Inventors: Chao-Chuan Cheng, Hsin-Chu City (TW); Ching-Lai Yeh, Tainan City (TW); Wei-Hsin Wang, Hualien City (TW)

Correspondence Address: CURATOLO SIDOTI CO., LPA, 24500 CENTER RIDGE ROAD, SUITE 280, CLEVELAND, OH, 44145, US

(21) Appl. No.: 12/331,511

(22) Filed: Dec. 10, 2008

(30) Foreign Application Priority Data
Dec. 12, 2007 (TW) 096147375

(51) Int. Cl. H05B 3/00

(52) U.S. Cl. 219/201

(57) ABSTRACT

An electric heating device includes: a conductive fabric including a plurality of thread sets and a plurality of parallel first insulator threads, each of the thread sets including a plurality of parallel conductive threads interlaced with the first insulator threads; and a heat-generating material covering the conductive fabric. The heat-generating material has a resistivity greater than a resistivity of the conductive threads.

### CROSS-REFERENCE TO RELATED APPLICATION

This application claims priority of Taiwanese application no. 096147375, filed on Dec. 12, 2007.

### BACKGROUND OF THE INVENTION

1. Field of the Invention

This invention relates to an electric heating device, more particularly to an electric heating device having a plurality of conductive sets, each of the conductive sets including a plurality of parallel conductive threads interlaced with a plurality of insulator threads.

2. Description of the Related Art

U.S. Pat. No. 6,194,692 discloses a conventional electric heating device (see FIG. 1) including a substrate 12, an heat-generating material 16 disposed on the substrate 12, a pair of electrodes 18 (only one electrode is shown) disposed on the heat-generating material 16, a current distributing element 19 disposed on the heat-generating material 16, and insulator layers 11, 14, 20, 13. When a current is applied on the electrodes 18, the heat-generating material 16 will generate heat.

DE Patent No. 10211721 discloses an electric heating device (see FIG. 2) including interlaced threads 2, each of which has a non-conductive core 22 and a conductive heat-generating coating 21 coated on the core 22, and two electrode strips 23 connected to the threads 2 and functioning as electrodes for the electric heating device. However, when the electric heating device is broken, the current distribution of the coating 21 becomes non-uniform.

In addition, both of the aforesaid conventional electric heating devices require the electrodes to be positioned at two ends or two sides thereof.

### SUMMARY OF THE INVENTION

Therefore, an object of the present invention is to provide an electric heating device that can overcome the aforesaid drawbacks associated with the prior art.

According to the present invention, a conductive fabric includes a plurality of thread sets and a plurality of parallel first insulator threads extending in a first direction, each of the thread sets including a plurality of parallel conductive threads extending in a second direction transverse to the first direction and interlaced with the first insulator threads; and a heat-generating material covering the conductive fabric, in electrical contact with the conductive threads of the thread sets of the conductive fabric, and capable of generating heat when a current is applied thereto through the conductive threads. The heat-generating material has a resistivity greater than a resistivity of the conductive threads.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary exploded sectional view of a conventional electric heating device;

FIG. 2 is a fragmentary schematic top plan view of another conventional electric heating device;

FIG. 3 is a fragmentary cutaway top plan view of the first preferred embodiment of an electric heating device according to this invention;

FIG. 4 is a fragmentary sectional view of the first preferred embodiment;

FIGS. 5 to 8 are fragmentary cutaway top plan views of the first preferred embodiment, illustrating different positions of a cut(s) formed therein;

FIG. 9 is a fragmentary cutaway top plan view of the second preferred embodiment of the electric heating device according to this invention;

FIG. 10 is a fragmentary cutaway top plan view of the third preferred embodiment of the electric heating device according to this invention;

FIG. 11 is a fragmentary perspective view of a conductive thread of the fourth preferred embodiment of the electric heating device according to this invention;

FIG. 12 is a fragmentary sectional view of the fifth preferred embodiment of the electric heating device according to this invention;

FIG. 13 is a fragmentary sectional view of the sixth preferred embodiment of the electric heating device according to this invention;

FIG. 14 is a fragmentary sectional view of the seventh preferred embodiment of the electric heating device according to this invention;

FIG. 15 is a fragmentary sectional view of the eighth preferred embodiment of the electric heating device according to this invention;

FIG. 16 is a fragmentary sectional view of the ninth preferred embodiment of the electric heating device according to this invention;

FIG. 17 is a fragmentary sectional view of the tenth preferred embodiment of the electric heating device according to this invention; and

FIG. 18 is a fragmentary sectional view of the eleventh preferred embodiment of the electric heating device according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

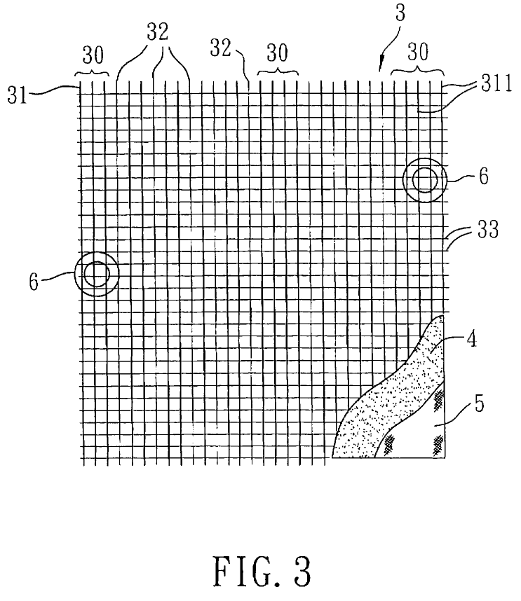

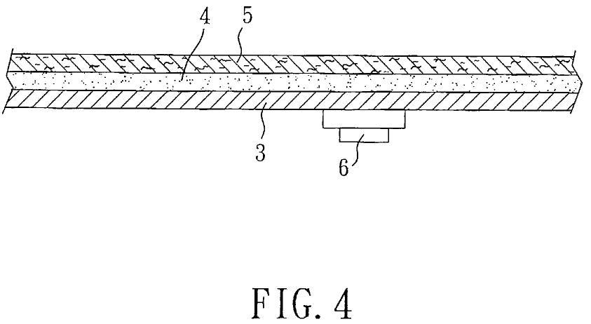

FIGS. 3 and 4 illustrate the first preferred embodiment of an electric heating device according to this invention.

The electric heating device includes: a conductive fabric 3 including a plurality of conductive sets 30, and a plurality of parallel first insulator threads 33 extending in a first direction, each of the thread sets 30 including a plurality of parallel conductive threads 31 extending in a second direction transverse to the first direction and interlaced with the first insulator threads 33; and a heat-generating material 4 covering the conductive fabric 3, in electrical contact with the conductive threads 31 of the thread sets 30 of the conductive fabric 3, and capable of generating heat when a current is applied thereto through the conductive threads 31.

In this embodiment, the heat-generating material 4 has a resistivity greater than a resistivity of the conductive threads 31.

In this embodiment, each of the thread sets 30 of the conductive fabric 3 further includes a plurality of second insulator threads 32 interposed among and parallel to the conductive threads 31, and interlaced with the first insulator threads 33.

The conductive fabric 3 can be warp-insert warp knitted, weft-insert warp knitted, or angle-insert warp knitted.

Preferably, each of the conductive threads 31 of the thread sets 30 is made from a conductor material selected from the group consisting of metals, conductive polymers, metal-coated polymers, and combinations thereof.

In this embodiment, each of the conductive threads 31 of the thread sets 30 has a metal wire 311 that is made from stainless steel and that has a density ranging from 5 g/km to 3000 g/km.

Preferably, each of the first and second insulator threads 33, 32 is made from a material selected from one of a natural fiber, an artificial fiber, and combinations thereof, and has a density ranging from 1 g/km to 400 g/km.

Preferably, the metal wire 311 has a diameter substantially equal to that of the first insulator threads 33.

In this embodiment, the conductive fabric 3 is a plain-woven structure. Alternatively, the conductive fabric 3 can be one of a basket-woven structure, a twill-woven structure, a satin-woven structure, a warp/weft rib-woven structure, a jacquard-woven structure, or combinations thereof.

Preferably, the conductive fabric 3 has a weaving density ranging from 30 to 500 threads per square inch.

Preferably, the resistivities of the heat-generating material 4 and the conductive threads 31 range from 0.1 Ω·cm to 10Ω·cm, and from 1×10⁻³ Ω·cm to 1×10⁻⁶ Ω·cm, respectively. In this embodiment, the resistivities of the heat-generating material 4 and the conductive threads 31 are 0.5 Ω·cm and 7.4×10⁻⁵ Ω·cm, respectively.

Preferably, the ratio of the number of the conductive threads 31 of the thread sets 30 to that of the second insulator threads 32 ranges from 10:1 to 1:10.

In this embodiment, the heat-generating material 4 is made from a conductive slurry including a conductive powder, a resin, and a solvent. Preferably, a cross-linking agent is added into the conductive slurry for adjustment of properties, such as mechanical strength, corrosion-resistance, and heat-resistance.

Preferably, the conductive powder is selected from the group consisting of carbon powder, metal powder, carbon fiber powder, and combinations thereof, and is in an amount ranging from 1 wt % to 25 wt %.

Preferably, the resin is made from a thermoplastic polymer selected from the group consisting of polyester, polyamine, polycarbonate, polyethylene, polypropylene, polyvinyl alcohol, and combinations thereof or a polymer selected from the group consisting of polyester polyurethane, polyether polyurethane, polycarbonate polyurethane, and combinations thereof, and is in an amount ranging from 1 wt % to 25 wt %.

Preferably, the solvent is selected from the group consisting of dimethylformamine, acetone, butanone, toluene, isopropyl alcohol, and combinations thereof.

In this embodiment, formation of the heat-generating material 4 is conducted by applying the conductive slurry on the conductive fabric 3, followed by drying the former to remove the solvent so as to obtain the electric heating device.

In this embodiment, the electric heating device further includes an insulator layer 5 attached to the heat-generating material 4 and made from a soft and flexible material, such as cloth or plastic.

Preferably, attachment of the insulator layer 5 to the heat-generating material 4 is conducted through one of stitching, adhesion, hot melting, and clipping.

In this embodiment, the electric heating device further includes first and second electric connectors 6 coupled electrically to a predetermined number of the conductive threads 31 of the thread sets 30 of the conductive fabric 3, and disposed at two opposite sides of the conductive fabric 3, respectively. In addition the remaining conductive threads 31 of the thread sets 30 are disposed between the first and second electric connectors 6.

Preferably, connection of the electric connectors 6 with the conductive threads 31 of the thread sets 30 is conducted through clipping, fastening, welding, adhesion, or combinations thereof.

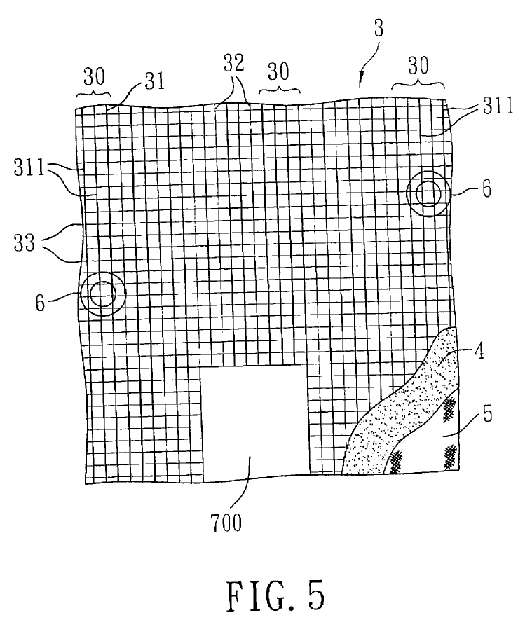

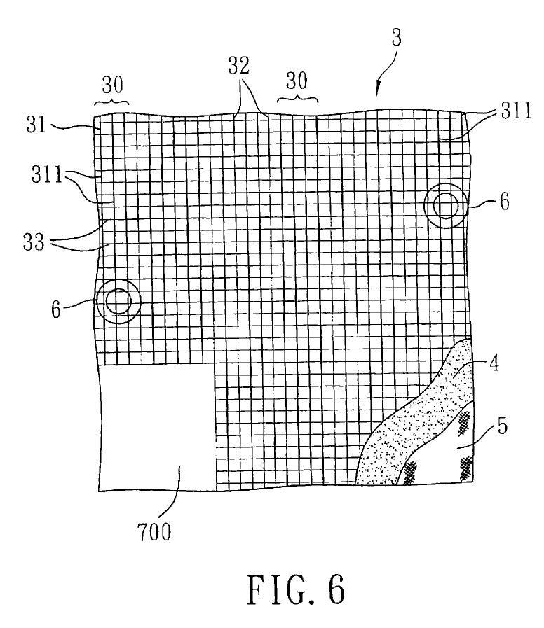

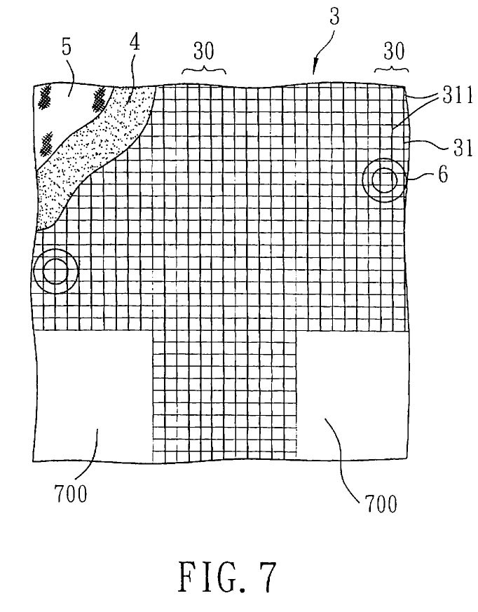

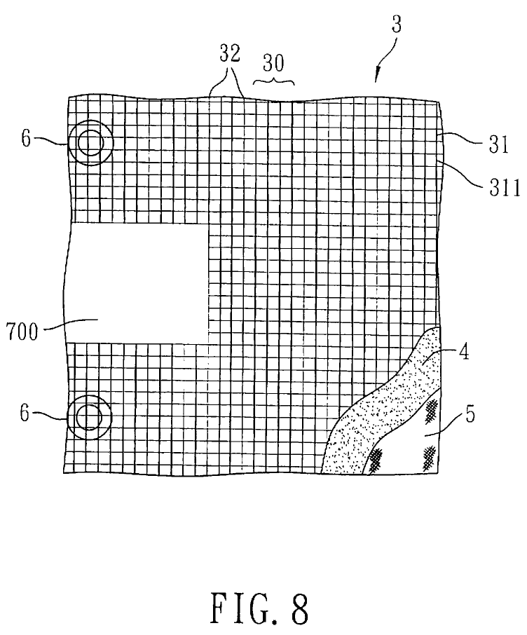

It is noted that since the heat-generating material 4 has a uniform structure and a higher resistivity than that of the conductive threads 31 of the thread sets 30, each of the conductive threads 31 can be regarded as a line-shaped electrode and a current distributor so that the heat-generating material 4 can generate heat uniformly throughout the entire conductive fabric 3, thereby avoiding localized overheating. Hence, the electric connectors 6 can be disposed at the middle of the conductive fabric 3, or at the same side of the conductive fabric 3, at any positions according to actual requirements. In addition, when a portion of the heat-generating material 4 is damaged, such as by a cut 700 being formed in the electric heating device (see FIGS. 5-8) a uniform current distribution throughout the conductive fabric 3 can be maintained by virtue of arrangement of some of the conductive threads 31 of the thread sets 30 between the first and second electric connectors 6.

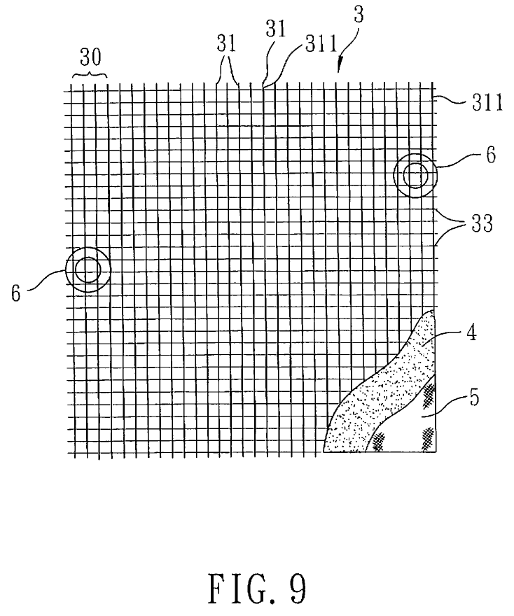

As shown in FIG. 9, the second preferred embodiment of the electric heating device according to the present invention has a structure similar to that of the previous embodiment, and differs from the latter in that the conductive fabric 3 of this embodiment dispenses with the second insulator threads 32.

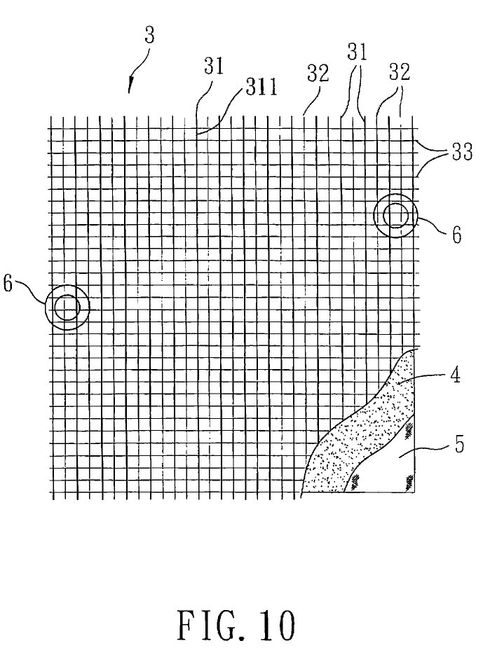

As shown in FIG. 10, the third preferred embodiment of the electric heating device according to the present invention has a structure similar to that of the first preferred embodiment, and differs from the latter in that the second insulator threads 32 are disposed alternately with the metal wires 311 of the conductive warp threads 31 of the thread sets 30.

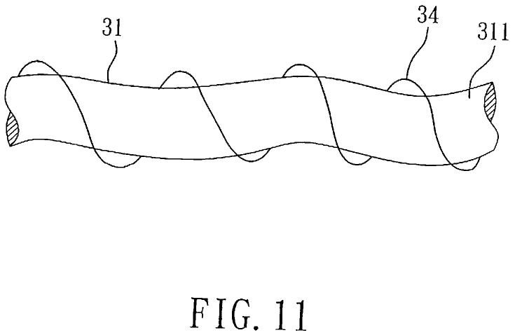

As shown in FIG. 11, the fourth preferred embodiment of the electric heating device according to the present invention differs from the first preferred embodiment in that the metal wire 311 of each of the conductive threads 31 of the thread sets 30 has an insulator filament 34 wound thereon and twisted therealong.

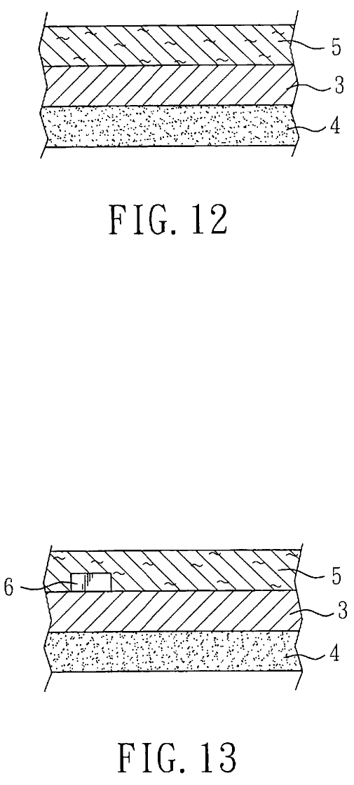

As shown in FIG. 12, the fifth preferred embodiment of the electric heating device according to the present invention has a structure similar to that of the first preferred embodiment, and differs from the latter in that the insulator layer 5 is attached to the conductive fabric 3 instead.

As shown in FIG. 13, the sixth preferred embodiment of the electric heating device according to the present invention has a structure similar to that of the fifth preferred embodiment, and differs from the latter in that the electric connectors 6 (only one is shown) are embedded in the insulator layer 5.

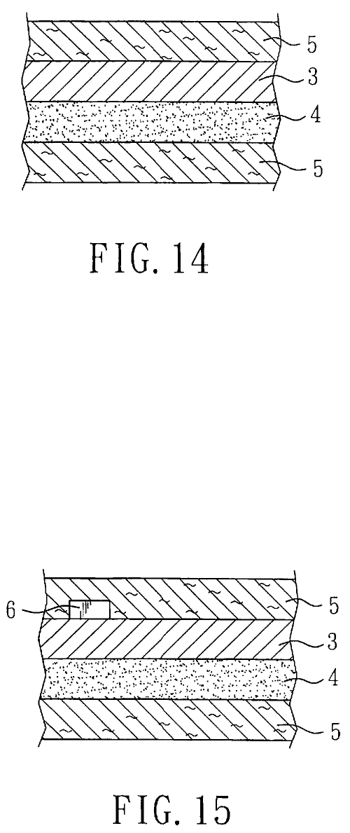

As shown in FIG. 14, the seventh preferred embodiment of the electric heating device according to the present invention has a structure similar to that of the first preferred embodiment, and differs from the latter in that a second insulator layer 5 is further included in this embodiment and is attached to the conductive fabric 3.

As shown in FIG. 15, the eighth preferred embodiment of the electric heating device according to the present invention has a structure similar to that of the seventh preferred embodiment, and differs from the latter in that the electric connectors 6 (only one connector 6 is shown) are embedded in the insulator layers 5.

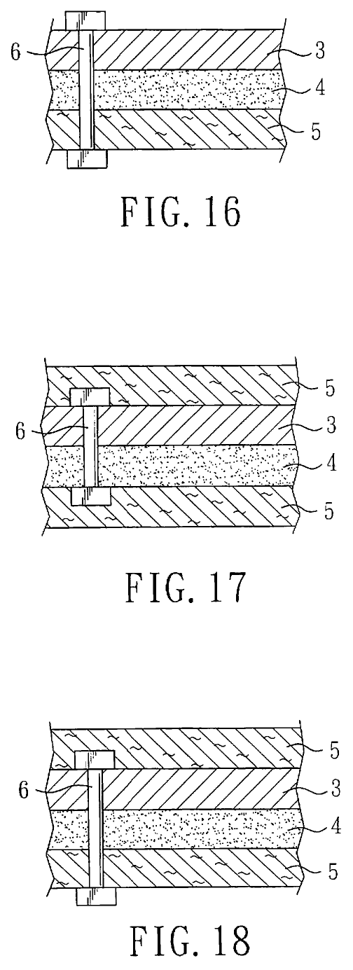

As shown in FIG. 16, the ninth preferred embodiment of the electric heating device according to the present invention has a structure similar to that of the first preferred embodiment, and differs from the latter in that each of the electric connectors 6 (only one is shown) is configured as a rivet extending through the conductive fabric 3, the heat-generating material 4 and the insulator layer 5.

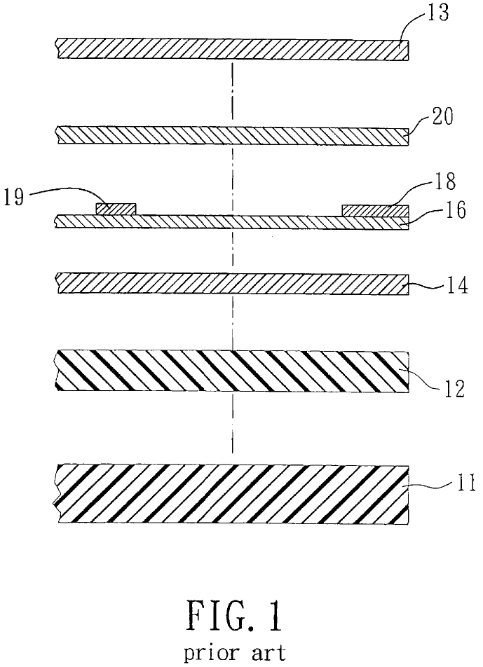

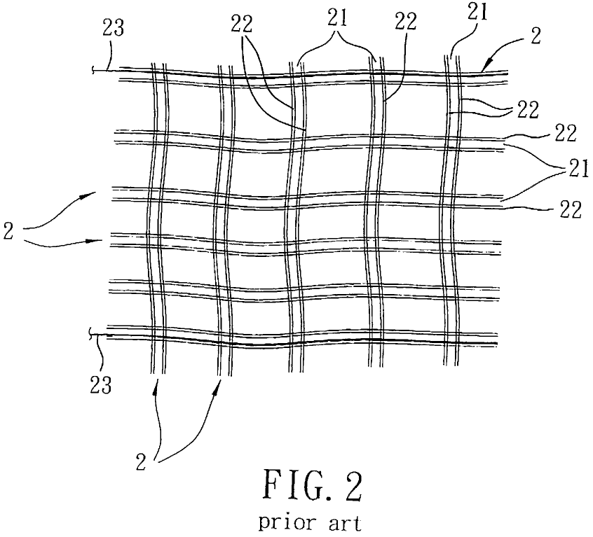

As shown in FIG. 1, the tenth preferred embodiment of the electric heating device according to the present invention has a structure similar to that of the eighth preferred embodiment, and differs from the latter in that each of the electric connectors 6 (only one is shown) is configured as a rivet extending through the conductive fabric 3 and the heat-generating material 4 and having two opposite heads embedded respectively in the insulator layers 5.

As shown in FIG. 18, the eleventh preferred embodiment of the electric heating device according to the present invention has a structure similar to that of the eighth preferred embodiment, and differs from the latter in that each of the electric connectors 6 (only one is shown) is configured as a rivet extending through the conductive fabric 3, the heat-generating material 4 and a lower one of the insulator layers 5.

By interlacing a plurality of the conductive threads 31 of the thread sets 30 with the first insulator threads 33 to form the conductive fabric 3 of the electric heating device of this invention, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. An electric heating device comprising:
a conductive fabric including a plurality of thread sets, and a plurality of parallel first insulator threads extending in a first direction, each of said thread sets including a plurality of parallel conductive threads extending in a second direction transverse to the first direction and interlaced with said first insulator threads; and
a heat-generating material covering said conductive fabric, in contact with said conductive threads of said thread sets of said conductive fabric, and capable of generating heat when a current is applied thereto through said conductive threads;
wherein said heat-generating material has a resistivity greater than a resistivity of said conductive threads.

2. The electric heating device of claim 1, wherein each of said thread sets of said conductive fabric further includes a plurality of second insulator threads parallel to said conductive threads and interlaced with said first insulator threads.

3. The electric heating device of claim 1, wherein each of said conductive threads has a metal wire and an insulator filament wound on and twisted along said metal wire.

4. The electric heating device of claim 1, further comprising first and second electric connectors coupled electrically to said conductive threads of said thread sets of said conductive fabric.

5. The electric heating device of claim 4, wherein said first and second electric connectors are disposed at two opposite sides of said conductive fabric, respectively.

6. The electric heating device of claim 4, wherein said first and second electric connectors extend through said conductive fabric and said heat-generating material

7. The electric heating device of claim 1, wherein said heat-generating material is made from a conductive slurry including a conductive powder, a resin, a solvent, and a cross-linking agent.

8. The electric heating device of claim 7, wherein said resin is made from a polymer selected from the group consisting of polyester polyurethane, polyether polyurethane, polycarbonate polyurethane, and combinations thereof.

9. The electric heating device of claim 7, wherein said resin is a thermoplastic polymer.

10. The electric heating device of claim 9, wherein said thermoplastic polymer is selected from the group consisting of polyester, polyamine, polycarbonate, polyethylene, polypropylene, polyvinyl alcohol, and combinations thereof.

11. The electric heating device of claim 7, wherein said conductive powder is selected from the group consisting of carbon powder, metal powder, carbon fiber powder, and combinations thereof.

12. The electric heating device of claim 1, wherein each of said conductive threads is made from a conductor material selected from the group consisting of metals, conductive polymers, metal-coated polymers, and combinations thereof.

13. The electric heating device of claim 1, wherein each of said conductive threads has a density ranging from 5 g/km to 3000 g/km.

14. The electric heating device of claim 1, wherein each of said insulator threads has a density ranging from 1 g/km to 400 g/km.

15. The electric heating device of claim 1, wherein each of said insulator threads is made from a material selected from one of a natural fiber and an artificial fiber.

16. The electric heating device of claim 1, wherein said conductive fabric has a weaving density ranging from 30 to 500 threads per square inch.

17. The electric heating device of claim 3, wherein said insulator filament wound on said metal wire of each of said conductive threads has a twist number ranging from 50 to 2000 per meter.

18. The electric heating device of claim 1, wherein the resistivity of said heat-generating material ranges from 0.1 Ω·cm to 10 Ω·cm.

19. The electric heating device of claim 1, wherein the resistivity of said conductive threads ranges from 1×10⁻³ Ω·cm to 1×10⁻⁶ Ω·cm.

20. The electric heating device of claim 1, further comprising a first insulator layer attached to said, and a second insulator layer attached to said conductive fabric.
